(19) United States
(12) Patent Application Publication
(10) Pub. No.: US 2009/0240577 A1
(43) Pub. Date: Sep. 24, 2009

(54) Method and Apparatus for Sharing Data Using an Exchange Procedure in a Network

(76) Inventor: R. Preston McAfee, San Marino, CA (US)

Correspondence Address: STATTLER - SUH PC, 60 SOUTH MARKET STREET, SUITE 480, SAN JOSE, CA, 95113, US

(21) Appl. No.: 12/050,756

(22) Filed: Mar. 18, 2008

(51) Int. Cl. G06Q 30/00

(52) U.S. Cl. 705/14

(57) ABSTRACT

A method and apparatus are provided for sharing data using an exchange procedure in a network. In one example, the method includes receiving an opportunity from an auction to place an ad on a webpage, receiving valuable data from a data source, wherein the data source includes at least two databases of at least two entities, calculating a bid for the opportunity based on the valuable data, selecting a desired ad based on the valuable data, and sending the bid and the desired ad to the auction, wherein the valuable data of each particularly entity remains substantially unrevealed to others outside the particular entity.

### FIELD OF THE INVENTION

The present invention relates to advertising on the Internet. More particularly, the present invention relates to sharing data amongst entities in order to provide more effective advertising on the Internet.

### BACKGROUND OF THE INVENTION

An advertiser, such as Ford® or McDonald's®, generally contracts an advertising agency for ads in different media for its products. Such media may include Internet ads, including banner display ads, textual ads (which may appear as hyperlinks), streaming ads (which stream across a digital display like stock quotes), mobile phone ads, print media ads, for example, in newspapers, magazines and posters.

A company like Yahoo!® gathers enormous amounts of data related to IP (Internet Protocol) addresses of consumer computers. For example, Yahoo!® sees IP addresses from which Yahoo!® can usually infer zip codes and even street-level data. Yahoo!® sees login information and sees the pages that consumers visit. Yahoo!® can infer age, gender, income and other demographic information from analyzing the pages a consumer visits even if the consumer never does a search. Of course, Yahoo!® also gathers valuable search data when consumers perform search queries. All of this data is highly valuable to any company that advertises because the data may help the company advertise in the most effective way.

A company like Yahoo!® is not the only type of company with valuable consumer information. A consumer typically visits many websites. Accordingly, data about the consumer is spread widely over many different companies. It can be useful to combine data from the many different companies. For example, if a company could utilize data gathered by another company like Yahoo!®, the appropriate ad for a particular consumer may change. In another example, if a company can find out from other companies that a consumer visits many auto websites (as opposed to just one website), the appropriate ad for that consumer may change.

Unfortunately, merely sharing the data substantially reduces the value of the data. Once other companies receive the data, the data is no longer private (or valuable). Thus, in order to utilize the data, the other companies no longer need to deal with the company that provided the data.

### SUMMARY OF THE INVENTION

What is needed is an improved method having features for addressing the problems mentioned above and new features not yet discussed. Broadly speaking, the present invention fills these needs by providing a method and apparatus for sharing data using an exchange procedure in a network. It should be appreciated that the present invention can be implemented in numerous ways, including as a method, a process, an apparatus, a system or a device. Inventive embodiments of the present invention are summarized below.

In one embodiment, a method is provided for sharing data using an exchange procedure in a network. The method comprises receiving an opportunity from an auction to place an ad on a webpage; receiving valuable data from a data source, wherein the data source includes at least two databases of at least two entities, calculating a bid for the opportunity based on the valuable data; selecting a desired ad based on the valuable data; and sending the bid and the desired ad to the auction, wherein the valuable data of each particularly entity remains substantially unrevealed to others outside the particular entity.

In another embodiment, a method is provided for sharing data using an exchange procedure in a network. The method comprises performing machine learning to establish rules and metrics for bidding on ad placement opportunities; receiving an opportunity from an auction to place an ad on a webpage; receiving valuable data from a data source, wherein the data source includes at least two databases of at least two entities; calculating a bid for the opportunity based on the valuable data and on the machine learning; selecting a desired ad based on the valuable data and on the machine learning; and sending the bid and the desired ad to the auction, wherein the valuable data of each particularly entity remains substantially unrevealed to others outside the particular entity.

In still another embodiment, an apparatus is provided for sharing data using an exchange procedure in a network. The apparatus comprises a receiving device configured to receive an opportunity from an auction to place an ad on a webpage, wherein the receiving device is further configured to receive valuable data from a data source, wherein the data source includes at least two databases of at least two entities; a calculating device configured to calculate a bid for the opportunity based on the valuable data, wherein the calculating device is further configured to select a desired ad based on the valuable data; and a sending device configured to send the bid and the desired ad to the auction, wherein the valuable data of each particularly entity remains substantially unrevealed to others outside the particular entity.

In yet another embodiment, an apparatus is provided for sharing data using an exchange procedure in a network, wherein the apparatus is configured to perform machine learning to establish rules and metrics for bidding on ad placement opportunities. The apparatus comprises a receiving device configured to receive an opportunity from an auction to place an ad on a webpage, wherein the receiving device is further configured to receive valuable data from a data source, wherein the data source includes at least two databases of at least two entities; a calculating device configured to calculate a bid for the opportunity based on the valuable data and on the machine learning, wherein the calculating device is further configured to select a desired ad based on the valuable data and on the machine learning; and a sending device configured to send the bid and the desired ad to the auction, wherein the valuable data of each particularly entity remains substantially unrevealed to others outside the particular entity.

In still yet another embodiment, a computer readable medium carrying one or more instructions for sharing data using an exchange procedure in a network is provided. The one or more instructions, when executed by one or more processors, cause the one or more processors to perform the steps of receiving an opportunity from an auction to place an ad on a webpage; receiving valuable data from a data source, wherein the data source includes at least two databases of at least two entities; calculating a bid for the opportunity based on the valuable data; selecting a desired ad based on the valuable data; and sending the bid and the desired ad to the auction, wherein the valuable data of each particularly entity remains substantially unrevealed to others outside the particular entity.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for sharing data using an exchange procedure in a network, in accordance with an embodiment of the present invention; and

FIG. 2 is a schematic diagram of a system for sharing data using an exchange procedure in a network, in accordance with an embodiment of the present invention;

FIG. 3 is a schematic diagram of a system for sharing data using a machine learning exchange procedure in a network, in accordance with an embodiment of the present invention;

FIG. 4 is a flowchart of a method of sharing data using an exchange procedure in a network, in accordance with an embodiment of the present invention;

FIG. 5 is a flowchart of a method of sharing data using an exchange procedure carried out by the bidding device of FIG. 2, in accordance with an embodiment of the present invention; and

FIG. 6 is a flowchart of a method of sharing data using an exchange procedure carried out by the machine learning device of FIG. 3, in accordance with an embodiment of the present invention.

### DETAILED DESCRIPTION OF THE INVENTION

An invention for a method and apparatus for sharing data using an exchange procedure in a network is disclosed. Numerous specific details are set forth in order to provide a thorough understanding of the present invention. It will be understood, however, to one skilled in the art, that the present invention may be practiced with other specific details.

### General Overview

Companies can take advantage of data each other have. However, once seen by others, data ceases to be private and, thus, ceases to be as valuable. The present invention limits the sharing while preserving the utility of data.

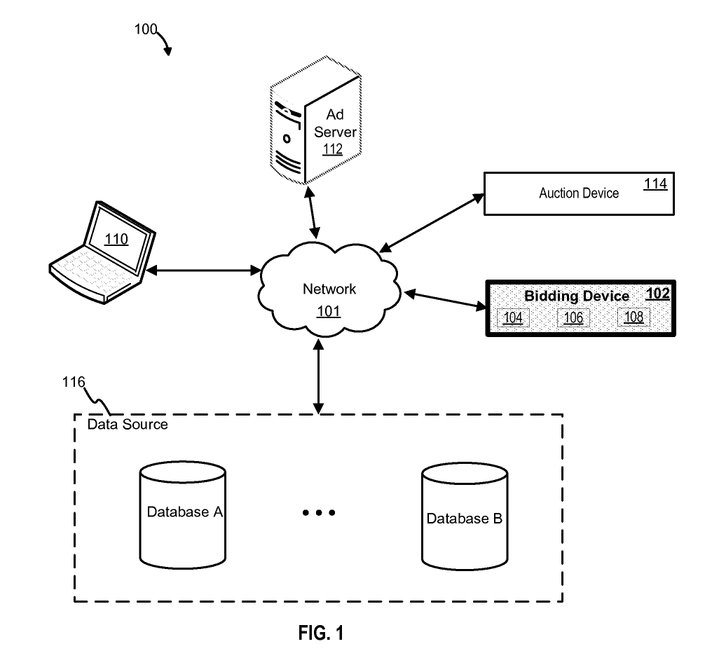

FIG. 1 is a block diagram of a system 100 for sharing data using an exchange procedure in a network 101, in accordance with an embodiment of the present invention. The network 101 couples together a consumer computer 110, an ad server 112, an auction device 114, a bidding device 102 and a data source 116. The network 101 may be any combination of networks, including without limitation the Internet, a local area network, a wide area network, a wireless network and a cellular network.

A device of the present invention is hardware, software or a combination thereof. Each device is configured to carry out one or more steps for the method of sharing data using an exchange procedure in the network 101. A device may sometimes be referred to as an apparatus. The bidding device 102 includes a receiver device 104, a calculating device 106 and a sending device 108.

The data source 116 includes at least one database. FIG. 1 shows the data source 116 as including Database A and Database B. Database A holds data of one entity, for example, a company like Yahoo!®. Database B holds data of another entity, for example, another company like Amazon.com®. These two companies, Yahoo!® and Amazon.com®, are used here for explanatory purposes and do not limit the scope the embodiment.

Companies like Yahoo!® and Ad.com have data that identify what ads will be effective. Such data may be useful to others, but once revealed it is no longer private. With the system 100, however, data can be useful while being substantially unrevealed. The bidding device 102 is configured to gather information from the data source 116 in a standard format. Based on the joined data, the bidding device 102 bids on an ad placement opportunity from the auction device 114 (i.e., ad exchange). If an ad is won, the ad server 112 sends the winning ad to the consumer computer 110 for display on the page. Alternatively, the ad server 112 is part of the auction device 114. Meanwhile, the data buyer preferably only sees the number of ads won and the overall price without knowing the particulars of the private (or valuable) data.

### Illustrative Examples

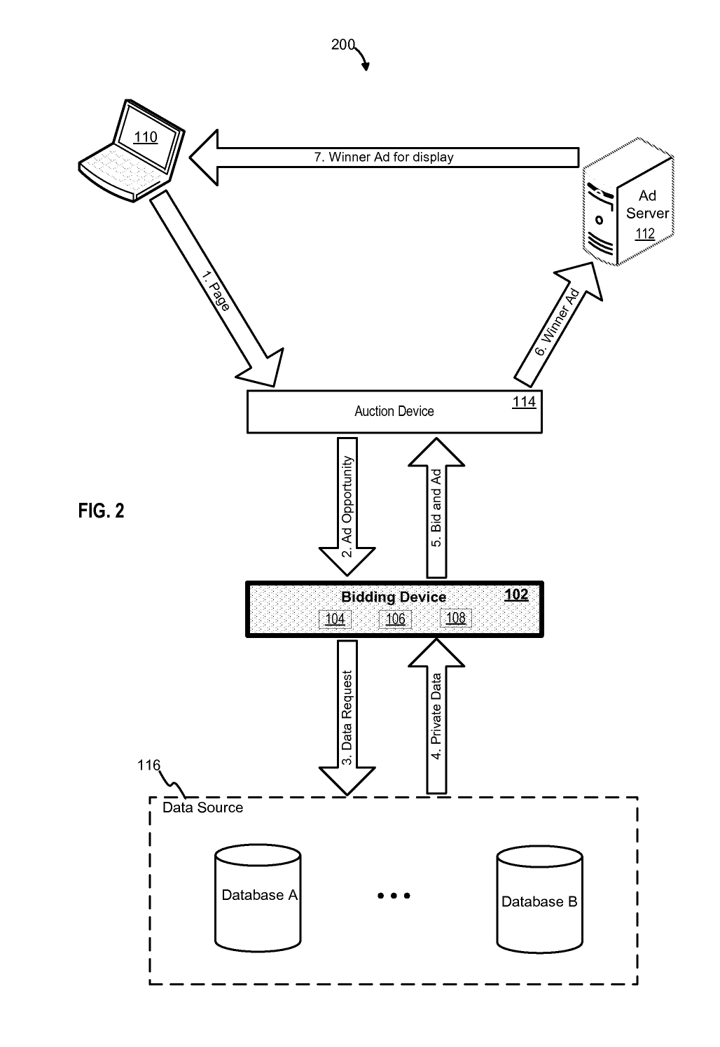

FIG. 2 is a schematic diagram of a system 200 for sharing data using an exchange procedure in a network, in accordance with an embodiment of the present invention. A consumer browses to a page at the consumer computer 110. Before the page loads on the consumer computer 110, the system 200 goes through a process of determining ads that are to be displayed on the page. This entire process will typically take substantially less than one second to complete.

The auction device 114 (i.e., ad exchange) receives the page to be displayed and identifies ad placement opportunities. Bidders on the Internet receive ad placement opportunities and bid on each opportunity individually. In other words, the bidders bid on the right to run an ad in a particular ad placement opportunity. There may easily be as many as 4,000 bidders or more for one ad placement opportunity. The bidding device 102 is one of the many bidders that receive an ad placement opportunity from the auction device 114.

A company like Yahoo!® has a mountain of data that may be useful to a company like Amazon.com® that wants to place the most effective display ad. A company like Yahoo!® gathers enormous amounts of data related to IP (Internet Protocol) addresses of consumer computers. For example, Yahoo!® sees IP addresses from which Yahoo!® can usually infer zip codes and even street-level data. Yahoo!® sees login information and sees the pages that consumers visit. Yahoo!® can infer age, gender, income and other demographic information from analyzing the pages a consumer visits even if the consumer never does a search. Of course, Yahoo!® also gathers valuable search data when consumers perform search queries. All of this data is highly valuable to any company that advertises because the data may help the company advertise in the most effective way.

A company like Amazon.com® may want to utilize, for example, demographic data that Yahoo!® has collected in its database. Amazon.com® may want to advertise only to women in Palo Alto, Calif. With the help of Yahoo!®, Amazon.com® may be able to target an ad in such a manner. The system 200 is configured in such a way that Amazon.com® may utilize the Yahoo!® data while the Yahoo!® data remains substantially unrevealed. In this example, Amazon.com® has data in Database B and wants to obtain customers. Amazon.com® turns to Yahoo!®, which holds data in Database A. Together, Yahoo!® and Amazon.com® program the bidding device 102 to carry out their needs so that both parties may benefit from the relationship.

The bidding device 102 is preferably a joint venture of the companies supplying the data source 116. The joint venture is jointly operated by the companies supplying the data source 116. Alternatively, the bidding device 102 is operated by an entity that is independent of the companies supplying the data source 116.

The bidding device 102 requests and receives private (or valuable) data from the data source 116, which includes databases of both Yahoo!® and Amazon.com®. Upon receiving the opportunity to run an ad, the bidding device 102 checks the ad placement opportunity against both databases, for example, the Yahoo!® database and the Amazon.com® database. If there are other databases in the data source 116, the bidding device 102 may check one or more of these other databases as well, depending on how the bidding device 102 is programmed. Alternatively, the bidding device checks the ad placement opportunity against only one database, for example, the Yahoo!® database only or the Amazon.com® database only. For example, the bidding device 102 may use only Yahoo!® data to determine a bid for a chosen Amazon.com® ad.

Based on programmed criteria, the bidding device 102 determines an appropriate bid and a desired ad for the ad opportunity. To help determine the value of the ad placement opportunity, the bidding device 102 may utilize consumer properties, such as IP addresses, demographics and Internet browse history. Alternatively, the bidding device 102 may utilize page content match. The following is an example of criteria that the companies may program into the bidding device 102: if the consumer shopped for books, then bid $2/1000 for this ad placement opportunity and show book ad X; if the consumer shopped for computers, then bid $10/1000 for this ad placement opportunity and show computer ad Y. The bidding device 102 may of course have substantially more complex bidding criteria.

The bidding device 102 sends the bid and the desired ad to the auction device 114. The auction device 114 takes the bid received from the bidding device 102 and compares that bid to other bids received from other entities on the Internet. The auction device 114 then determines the winner of the ad placement opportunity.

If the ad placement opportunity is won by the bidding device 102, the auction device 114 selects the desired ad that the bidding device 102 sent as the winning ad. Alternatively, the bidding device 102 may send the desired ad after the auction device 114 determines the winner of the ad placement opportunity. The ad server 112 receives notification of the winner ad and sends the winner ad to the consumer computer 110 for display on the page. Alternatively, the ad server 112 may be a part of the auction device 114.

Preferably, only if the ad is effective (e.g., customer clicks through ad) does Amazon.com® learn that the consumer computer 110 received the ad. Even then, Amazon.com® learns neither what the ad agency Yahoo!® knows about the customer nor what the bid price was. Preferably, only the bids won and the effective ads are reported back to Amazon.com®. More preferably, only the total sum of bids won and the total sum of effective ads are reported back to Amazon.com®. Thus, Yahoo!® reveals a minimal, one-time use of its private (or valuable) data to Amazon.com®.

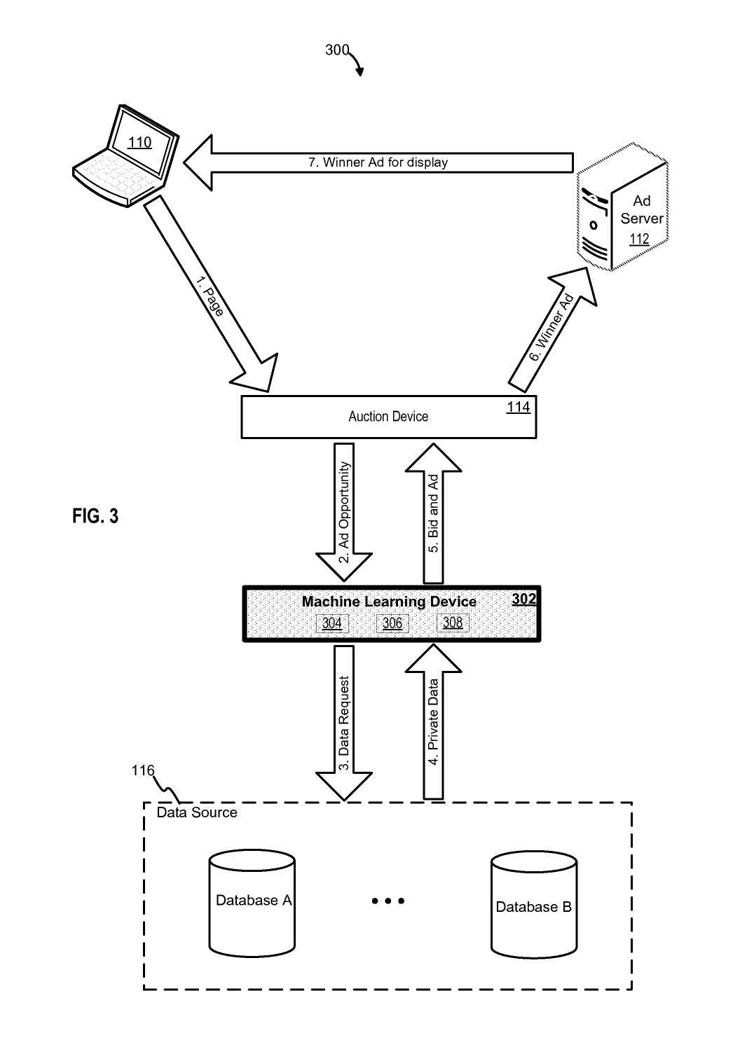

FIG. 3 is a schematic diagram of a system 300 for sharing data using a machine learning exchange procedure in a network, in accordance with an embodiment of the present invention. This system 300 is similar to the system 200 of FIG. 2, except the bidding device here is a machine learning device 302. The machine learning device 302 includes a receiver device 304, a calculating device 306 and a sending device 308.

With machine learning, no human ever really knows for certain why particular ads are run because there is so much data that the machine learning device 302 interrelates. The machine learning device 302 starts off having substantially no rules or metrics for bidding on ad placement opportunities. Over time, the machine learning device 302 gathers an enormous amount of data about effective ads in the Internet marketplace. The machine learning device 302 aggregates this data and establishes rules and metrics for bidding on ad placement opportunities. The machine learning device 302 gets to the point where it is able to place a bid for a particular ad based on the effectiveness of ads in the Internet marketplace. The machine learning device 302 may use cookie data from the databases of the data source 116, for example, the Yahoo!® database and the Amazon.com® database. Alternatively, the machine learning device 302 uses cookie data from the databases of several companies, or from the database of just one company.

With two or more companies and complex machine learning rules, it becomes important to establish fair prices for the use of data. The system can establish fair pricing by asking, on impressions that are won, what would have happened absent each database? That is, the system employs the rules with one data entry replaced by “missing observation”. If a won observation is now lost, that data entry has a claim on the value generated. If there are 2 or more claims on the value generated, each share equally. If there are no claims on the value generated (which is possible because removing one may not change winning but removing several may) the best thing is to do the similar exercise removing groups. However, sharing equally among individuals with non-empty data may suffice.

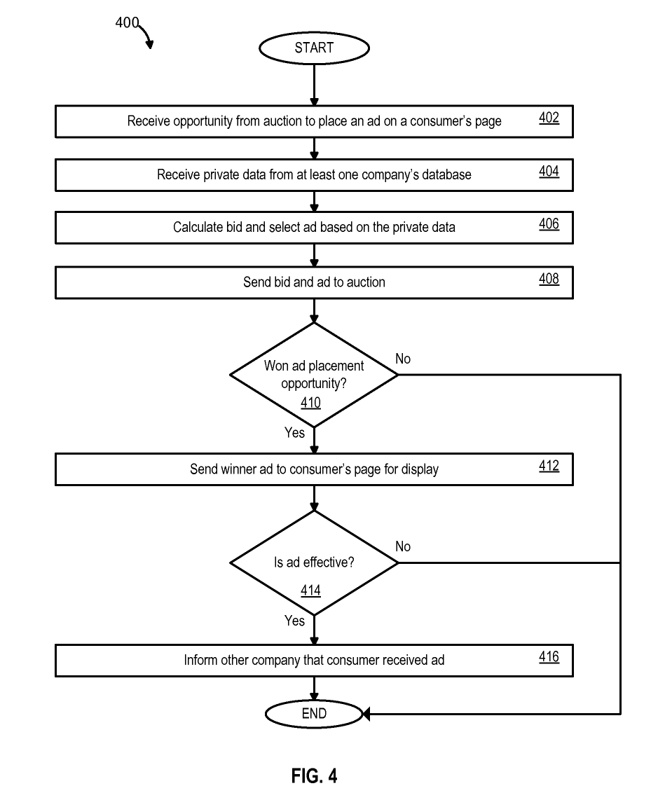

FIG. 4 is a flowchart of a method 400 of sharing data using an exchange procedure in a network, in accordance with an embodiment of the present invention. The method starts in step 402 where the system receives an opportunity from an auction to place an ad on a consumer's page. The bidding device 102 of FIG. 2 may be configured to carry out step 402. In step 404, the system receives private (or valuable) data from at least one database. Preferably, the system receives data from two or more databases. This step 404, involving receiving data from databases, may occur simultaneously with the system receiving ad placement opportunities. The bidding device 102 of FIG. 2 may be configured to carry out step 404.

The method 400 then moves to step 406 where the system calculates a bid and selects an appropriate ad based on the private (or valuable) data received from the databases. The bidding device 102 of FIG. 2 may be configured to carry out step 406. Next, in step 408, the system sends the bid and selected ad to the auction. The bidding device 102 of FIG. 2 may be configured to carry out step 408.

Proceeding to decision operation 410, the system determines if the ad placement opportunity was won. The auction device 114 of FIG. 2 may be configured to carry out decision operation 410. If the system determines that the ad placement opportunity is not won, the method 400 is at an end and may start over with another ad placement opportunity. On the other hand, if the system determines that the ad placement opportunity is won, the system moves on to step 412 where the system sends the winner ad to the consumer's page for display. The ad server 112 of FIG. 2 may be configured to carry out step 412.

Next, in decision operation 414, the system determines if the winner ad effective. In other words, the system determines if the consumer has utilized the ad, for example, by clicking through. If the system determines that the ad is not effective, the method 400 is at an end and may start over with another ad placement opportunity; the other company preferably does not receive information about the ad being displayed. On the other hand, if the system determines that the winner ad is effective, the system informs the other company that the consumer received the ad. In the example of FIG. 1, that other company would be Amazon.com® seeking to benefit from the data collected by Yahoo!®. The method 400 is then at an end.

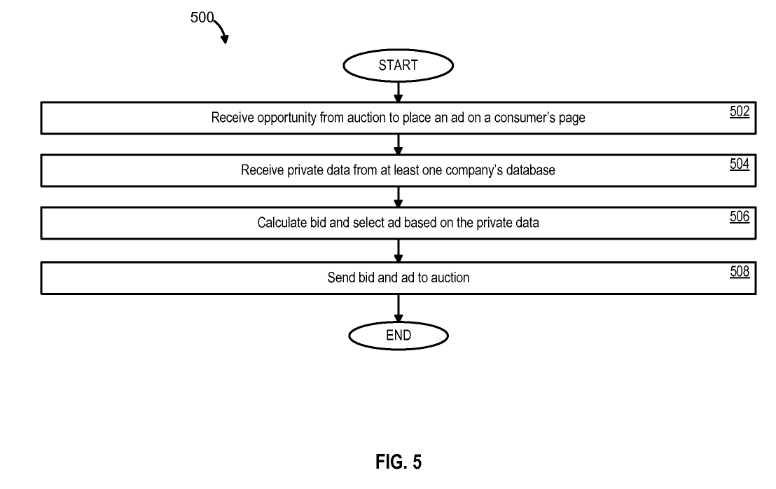

FIG. 5 is a flowchart of a method 500 of sharing data using an exchange procedure carried out by the bidding device 102 of FIG. 2, in accordance with an embodiment of the present invention. The method starts in step 502 where the bidding device receives an opportunity from an auction to place an ad on a consumer's page. In step 504, the bidding device receives private (or valuable) data from at least one database. Preferably, the bidding device receives data from two or more databases. This step 504, involving receiving data from databases, may occur simultaneously with the bidding device receiving ad placement opportunities. The method 500 then moves to step 506 where the bidding device calculates a bid and selects an appropriate ad based on the private (or valuable) data received from the databases. Next, in step 508, the bidding device sends the bid and selected ad to the auction. The method 500 is then at an end.

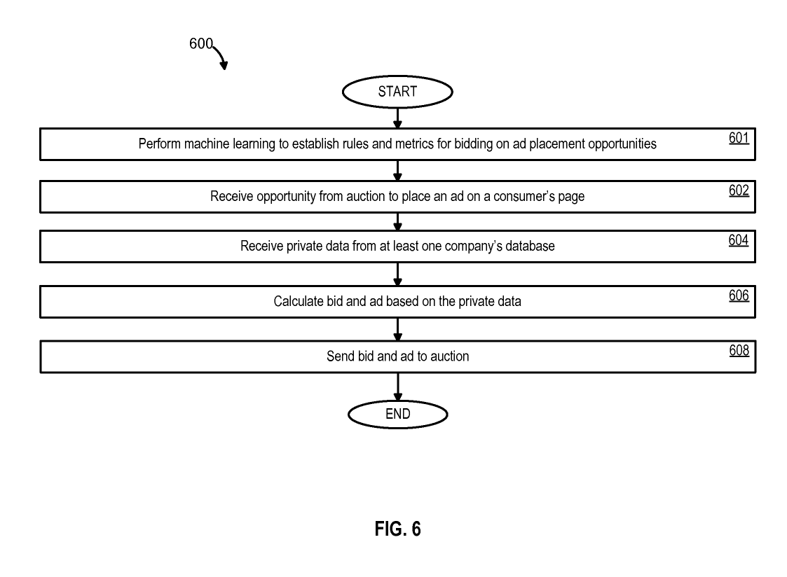

FIG. 6 is a flowchart of a method 600 of sharing data using an exchange procedure carried out by the machine learning device 302 of FIG. 3, in accordance with an embodiment of the present invention. The method 600 starts in step 601 where the machine learning device performs machine learning to establish rules and metrics for bidding on ad placement opportunities. The method 600 then moves to step 602 where the machine learning device receives an opportunity from an auction to place an ad on a consumer's page. In step 604, the machine learning device receives private (or valuable) data from at least one database. Preferably, the machine learning device receives data from two or more databases. This step 604, involving receiving data from databases, may occur simultaneously with the machine learning device receiving ad placement opportunities. The method 600 then moves to step 606 where the machine learning device calculates a bid and selects an appropriate ad based on the private (or valuable) data received from the databases. Next, in step 608, the machine learning device sends the bid and selected ad to the auction. The method 600 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving an opportunity from an auction to place an ad on a webpage, receiving valuable data from a data source, wherein the data source includes at least two databases of at least two entities, calculating a bid for the opportunity based on the valuable data, selecting a desired ad based on the valuable data, and sending the bid and the desired ad to the auction, wherein the valuable data of each particularly entity remains substantially unrevealed to others outside the particular entity, according to processes of the present invention.

### Advantages

The present invention limits the ability of an external user of private (or valuable) data to learn the actual values of the private data. Moreover, the invention may reduce the legal hazard of data sharing as the program need not share data, but instead just use a “yes or no” criterion that doesn't identify any personal characteristics. Companies do not want other companies to have full access to their data because the other companies then become competitors. By limiting the amount of private (or valuable) data revealed, a company like Yahoo!® can charge for the data value repeatedly, as opposed to charge once for access to the data.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of sharing data using an exchange procedure in a network, the method comprising:
receiving an opportunity from an auction to place an ad on a webpage;
receiving valuable data from a data source, wherein the data source includes at least two databases of at least two entities;
calculating a bid for the opportunity based on the valuable data;
selecting a desired ad based on the valuable data; and
sending the bid and the desired ad to the auction, wherein the valuable data of each particularly entity remains substantially unrevealed to others outside the particular entity.

2. The method of claim 1, wherein the data source includes a first database of a first company and a second database of a second company.

3. The method of claim 2, wherein the second company desires to place an ad with the opportunity, wherein valuable data in the first database of the first company is particularly useful to the second company.

4. The method of claim 1, wherein the valuable data includes IP addresses of consumer computers, wherein the calculating the bid comprises considering the IP addresses.

5. The method of claim 1, wherein the valuable data includes at least one of demographics and Internet browse history of consumers, wherein the calculating the bid comprises considering at least one of the demographics and the Internet browse history.

6. The method of claim 2, further comprising:
determining that the bid won the opportunity; and
informing the second company that the bid won the opportunity.

7. The method of claim 6, further comprising sending the desired ad to the webpage.

8. The method of claim 2, further comprising:
determining that the desired ad was effective; and
informing the second company that the webpage received the desired ad.

9. A method of sharing data using an exchange procedure in a network, the method comprising:
performing machine learning to establish rules and metrics for bidding on ad placement opportunities;
receiving an opportunity from an auction to place an ad on a webpage;
receiving valuable data from a data source, wherein the data source includes at least two databases of at least two entities;
calculating a bid for the opportunity based on the valuable data and on the machine learning;
selecting a desired ad based on the valuable data and on the machine learning; and
sending the bid and the desired ad to the auction, wherein the valuable data of each particularly entity remains substantially unrevealed to others outside the particular entity.

10. The method of claim 9, wherein the performing machine learning comprises gathering data about effective ads in the Internet marketplace.

11. The method of claim 9, wherein the data source includes a first database of a first company and a second database of a second company.

12. The method of claim 11, wherein the second company desires to place an ad with the opportunity, wherein valuable data in the first database of the first company is particularly useful to the second company.

13. The method of claim 9, wherein the valuable data includes IP addresses of consumer computers, wherein the calculating the bid comprises using the machine learning rules and metrics to consider the IP addresses.

14. The method of claim 9, wherein the valuable data includes at least one of demographics and Internet browse history of consumers, wherein the calculating the bid comprises using the machine learning rules and metrics to consider at least one of the demographics and the Internet browse history.

15. An apparatus for sharing data using an exchange procedure in a network, the apparatus comprising:
a receiving device configured to receive an opportunity from an auction to place an ad on a webpage, wherein the receiving device is further configured to receive valuable data from a data source, wherein the data source includes at least two databases of at least two entities;
a calculating device configured to calculate a bid for the opportunity based on the valuable data, wherein the calculating device is further configured to select a desired ad based on the valuable data; and
a sending device configured to send the bid and the desired ad to the auction, wherein the valuable data of each particularly entity remains substantially unrevealed to others outside the particular entity.

16. The apparatus of claim 15, wherein the apparatus is a bidding device that is a joint venture of the entities.

17. The apparatus of claim 15, wherein the data source includes a first database of a first company and a second database of a second company.

18. The apparatus of claim 17, wherein the second company desires to place an ad with the opportunity, wherein valuable data in the first database of the first company is particularly useful to the second company.

19. The apparatus of claim 15, wherein the valuable data includes IP addresses of consumer computers, wherein the calculating device is further configured to consider the IP addresses.

20. The apparatus of claim 15, wherein the valuable data includes at least one of demographics and Internet browse history of consumers, wherein the calculating the bid comprises considering at least one of the demographics and the Internet browse history.
